(19) United States
(12) Patent Application Publication
(10) Pub. No.: US 2007/0031619 A1
(43) Pub. Date: Feb. 8, 2007

(54) Label for a pharmaceutical container

(75) Inventors: David L. Mirabell, Spokane, WA (US); Derek William Constable, Spokane, WA (US)

Correspondence Address: WILSON SONSINI GOODRICH & ROSATI, 650 PAGE MILL ROAD, PALO ALTO, CA, 94304-1050, US

(73) Assignee: Verus Pharmaceuticals, Inc.

(21) Appl. No.: 11/196,933

(22) Filed: Aug. 4, 2005

(51) Int. Cl. B31B 45/00

(52) U.S. Cl. 428/34.1; 428/343

(57) ABSTRACT

An invention provides a label for a pharmaceutical container. The label has at least two sections, one of which is affixed to the pharmaceutical container, the other section being connected to the container by the first label section. The label is adapted such that the second section can be wrapped around the container for storage and may be unrolled from the container and read by a user.

### FIELD OF THE INVENTION

The invention related to the general field of pharmaceutical containers, and in particular to a label for use on a medical container, such as a syringe or an automatic injector.

### BACKGROUND OF THE INVENTION

Injectable pharmaceuticals can be packaged in a variety of containers, such as ampoules and automatic injectors. In some cases, the ampoule is a small bottle that may have a scored neck for easy removal of the top of the ampoule. In other cases the ampoule is a bottle with a top that comprises a rubber septum through which liquid medication may be withdrawn via a syringe. The latter configuration is especially useful for medications that are packaged in multiple doses, whereas the former configuration with the removable top is generally limited to single-dose packaging.

Automatic injectors offer various advantages, especially where the person administering the parenteral drug is not a healthcare professional, and most especially when the drug is to be self-administered. An automatic injector generally includes a syringe that is pre-filled with injectable drug and a mechanism for automatically inserting the needle of the syringe into the patient's body and depressing the syringe plunger to deliver the drug into the patient's body. The pre-filled syringe is convenient for a user, as it obviates the awkward step of filling the syringe. The automatic injector is also convenient for the user as it permits the user to insert the syringe needle and inject the drug with a single motion, thereby decreasing the psychological reluctance of the patient to receive an injection.

In most jurisdictions, pharmaceutical compositions are required by law to be packaged with instructions for their use. Generally, small ampoules and automatic injectors bear a simple label affixed to their body, generally describing the contents of the container and the concentration of active pharmaceutical ingredient therein. More detailed labeling, including indications, contraindications, detailed information regarding known drug interactions and side effects have to be included in a package insert, as they are generally too detailed to be printed on a conventional container label. Especially in the case of automatic injectors, detailed instructions for use of the device are conventionally provided in a package insert. Because they are not attached to the pharmaceutical container, these instructions, which are necessary for the proper use and disposal of the device, may easily become separated from the device, thereby making it difficult, dangerous, or simply impossible to use the device.

Small ampoules may be packaged in a box containing plural ampoules and a single set of administration instructions. Again, the instructions may easily become separated from the ampoules themselves, thereby depriving the user, whether health care professional or patient, of the valuable usage instructions and warnings that are necessary for safe and effective use of the drug.

Thus, there is a need for a label to be used with pharmaceutical packaging that has sufficient surface area to permit printing of detailed directions, warnings or both thereof, but does not easily become separated from the drug container. The invention meets this need and provides other advantages as well.

### SUMMARY OF THE INVENTION

The invention meets the above-stated needs by providing a pharmaceutical container having a wrap label. The wrap label has two sections: a first section that adheres to a surface of the container and a second section that is connected to the first section but does not adhere directly to the container surface. Both the first and second sections may have printing thereon; and the second section may have printing on both sides. The wrap label may be unfurled to reveal the printing thereon; it may also be wrapped around the container (furled) for convenient storage and to keep it out of the way during use of the container to which it is affixed. The second section may also have applied to it a tacky substance that keeps the wrap label in its furled position after it has been wrapped around the container. The wrap label may also be applied in such a way as to maintain a bias toward the rolled position. In addition, the wrap label may have perforations that allow at least a portion of the label to be separated from the rest of the label.

The invention further provides a label for application to a pharmaceutical container, said label comprising a container adherent section adjacent to a wrap section. The container adherent section is adapted to affix to a surface of a container. The wrap section is adapted to wrap around said container.

The wrap label of the present invention provides certain advantages. By expanding the amount of printing area available for labeling, the wrap label provides greatly increased surface area for providing detailed usage instructions permanently affixed to a pharmaceutical container. In addition, in its furled position, the wrap label provides some lateral shock absorption, thereby rendering the container more durable. These and other advantages will become apparent to the person of skill in the art upon consideration of the description of the invention herein and the accompanying drawings and claims.

### BRIEF DESCRIPTION OF THE DRAWINGS

FIGS. 1A and 1B depict sides A and B of a label 10 of the invention.

FIG. 2A depicts a medical container having a label bearing portion to which a label according to the invention is to be attached to form a labeled article according to the invention.

FIGS. 2B and 2C each depict a side view of a combination 50 including a container 52 and a label 60, wherein the label is wrapped around the barrel of the container (furled) in FIG. 2A and is unfurled to reveal printed matter thereon in FIG. 2B.

FIG. 3A and 3B depict an cross-sectional end view of a combination 50 including a container 52 and a label 60, wherein the label is wrapped around the barrel of the container (furled) in FIG. 3A and is unfurled in FIG. 3B.

### DETAILED DESCRIPTION OF THE INVENTION

The present invention provides a label for a pharmaceutical container and a device comprising a pharmaceutical container and a label.

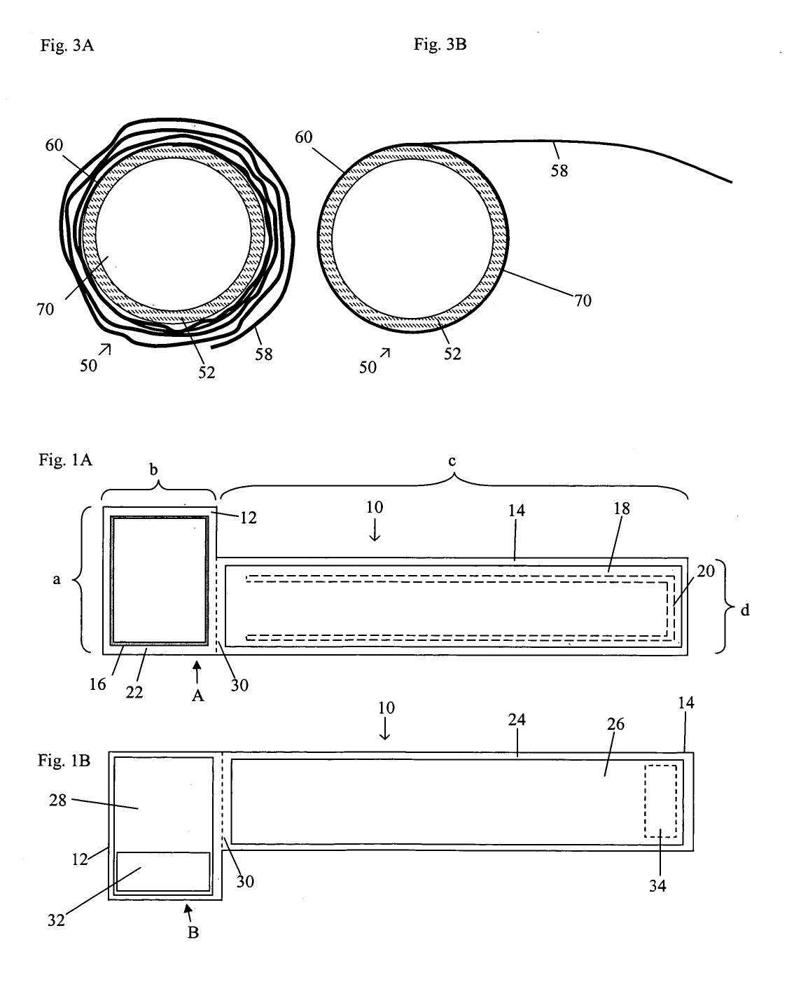

A label according to the invention can be envisioned with reference to FIGS. 1A and 1B. FIG. 1A shows a first side A of a label 10 according to the invention, while FIG. 1B shows a second side B of label 10. Label 10 comprises a container adherent section 12 and a wrap section 14. In FIG. 1A, side A of the container adherent section 12 has an adhesive receiving area 22 that has a permanent adhesive 16 applied to it. The permanent adhesive 16 is an adhesive capable of permanently attaching the container adherent section 12 to a surface of a pharmaceutical container. Although the adhesive 16 is depicted as a rectangular box around the periphery of the adhesive receiving area 22 of the container adherent section 12, the person skilled in the art will recognize that the adhesive 16 may be applied in a manner suitable for affixing the adhesive receiving area 22 to a surface of a pharmaceutical container. For example, the adhesive 16 may be applied in parallel strips, in criss-crossing strips or in another pattern suitable for binding the adhesive receiving area 22 to a surface of a pharmaceutical container.

In this context, the term “permanent adhesive” and its variants indicate that the adhesive is designed to keep the container adherent section 12 from easily dislodging from the surface of the pharmaceutical container during the course of normal use. Thus, the term “permanent adhesive” in this context includes adhesives that may be removed by means other than those normally encountered during the course of normal usage. Such a permanent adhesive may be dissolved with various solvents, softened with the application of heat or otherwise altered to allow the container adherent section 12 to be removed from a container by subjecting it to conditions that it would not encounter in the ordinary course of usage as a container for pharmaceuticals.

The term “container” means a device adapted to hold a quantity of a substance for a period of time. A “pharmaceutical container” means a device adapted to hold a quantity of a pharmaceutical substance for a period of time. Such a device can be a bottle, a syringe (alone or in combination with other parts of an automatic injector), an ampoule, a polymer bag, a box or other container. The device may be adapted to hold the pharmaceutical temporarily or indefinitely. The pharmaceutical held by the container can include pills, capsules, caplets, tablets, liquids, suspensions, powders or other suitable dosage forms. Particular embodiments of the container and pharmaceutical contained therein are discussed in more detail below.

The wrap section 14 contains printing areas 18 (side A, FIG. 1A) and 24 (side B, FIG. 1B). The printing areas 18 and 24 are adapted to receive printed indicia such as writing, drawings, illustrations or combinations or permutations of the same. The printed indicia may be adapted to convey information to the end user, such as drug use instructions, label, known indications, contraindications, drug interactions, etc. As shown in FIG. 1A, the wrap section 14 also optionally includes on one side a reversible adhesive strip 20. The reversible adhesive strip 20 is designed to hold the wrap section 14 in place in a furled position about the container when it is not being read by a user, such as during transportation and storage, and to allow the wrap section 14 to be unfurled so that it can be read by a user. In some embodiments, the reversible adhesive strip 20 allows the wrap section 14 to be furled and unfurled repeatedly without loss of tackiness, thus allowing the user to refer to the written indicia on the label 10 multiple times without loss of utility of the wrap label. Thus, the reversible adhesive strip 20 is advantageously a reversible pressure-sensitive adhesive. Suitable reversible adhesives are known in the art. Particularly suitable reversible adhesives are those that are tacky and pressure-sensitive, and which do not leave a residue upon a surface to which they have been exposed, even after prolonged contact. Such reversible adhesives are described, for instance, by Silver in U.S. Pat. No. 3,691,140, by Silver et al. in U.S. Pat. No. 3,922,464, and by Lau et al. in U.S. Pat. No. 4,780,367, each of which is incorporated herein by reference.

While the reversible adhesive strip 20 is depicted in FIG. 1A as defining three sides of a rectangle within the writing area 18, the person skilled in the art will recognize that a reversible adhesive may be applied in other patterns such as parallel strips, dots, criss-crossed strips or another arrangement that is suitable for this application. Where the reversible adhesive is applied in a pattern that would otherwise obscure the written indicia on the writing area 18, the adhesive is advantageously transparent or at the least translucent, allowing the user to read the indicia through the adhesive pattern.

The container adherent section 12 has a pair of dimensions: a longitudinal dimension a, which runs parallel to an axis of a container to which the label 10 is to be attached, and a circumferential dimension b. In some embodiments, the circumferential dimension b is roughly equivalent to the circumference of a pharmaceutical container to which the label 10 is to be affixed. (The term “circumference” does not necessarily mean that the container is circular in cross-section. Where the container is rectangular, triangular, octagonal, hexagonal, or oval in cross-section, the term “circumference” simply means the shortest distance around the outside of the container.) In some embodiments, the circumferential dimension b may be slightly larger than the circumference of the container to which the label is to be affixed, permitting a small degree of overlap for the adhesive section 12, whereas in other embodiments, the circumferential dimension b may be slightly less than the circumference of the container to which the container adherent section 12 is to be affixed.

Wrap section 14 has a longitudinal dimension d and a circumferential dimension c. The writing areas 18 and 24 are sized to permit printing of use instructions, product warnings, known drug interactions or other suitable printed matter in a size convenient for the typical user. In some cases, dimension d is less than dimension a. In other embodiments, dimension d is greater than dimension a. In still further cases, dimension a and d are roughly equivalent. Likewise dimension c may be greater than, less than or roughly equal to dimension b. In the embodiment depicted in FIGS. 1A and 1B, b<c and d<a, however the person skilled in the art will recognize that other dimensions are possible and in some cases desirable, depending on the amount and type of printed matter that the manufacturer wishes to present with the container. In general, the person skilled in the art will adjust the various dimensions a, b, c, and d so that the desired printed material can be printed on the label in a size and style suitable for the end user to conveniently read it, while at the same time allowing the container adherent section 12 to fit on the container. In some embodiments of the invention, a>d and c>>b. In particular embodiments of the invention c is at least five times b, for example from about 5 to about 15 times b.

On side B of the label 10, the container adherent section 12 has a container printing area 28, on which conveniently has printed matter thereon. Within container printing area 28 is critical printing area 32. The critical printing area 32 is located on a portion of the container printing area 28 that is generally visible to the user when the wrap section 14 is furled about a container. The critical printing area 32 is so called because it is an area on which critical information may be printed, such as the lot number and expiration date of the drug.

In some embodiments of label 10, the wrap section 14 has a special printing area 34 on which may be printed special information, such as the critical information mentioned above or other information that should be visible to the user when the wrap section 14 is furled. Such special information may include instructions for disposing of the container and its contents under certain conditions, such as when the container appears broken or if the contents are discolored or cloudy, or when the contents of the container have been spent. Thus, the special printing area 34 is an optional printing area, which may be excluded if the critical printing area 32 is large enough to display such information. In some embodiments, the critical printing area 32 may be eliminated in favor of the special printing area 34. Whether to include critical printing area 32, special printing area 34, both or neither depends upon the specific needs of the pharmaceutical manufacturer, provider, dispenser and user and may be affected by regulatory requirements.

In some embodiments, the label 10 optionally includes a perforation 30, which optionally allows removal of the wrap section 14 of the label 10 from the container adherent section 16. When present, the perforation 30 allows printed indicia on the wrap section 14 to be read by one individual while the remainder of the label remains on the container. In some embodiments, the detached wrap section 14 can be collected for use in an inventory system to track the use of drug and to inform responsible persons of the need to re-order expended pharmaceutical stock. In other embodiments, the perforation 30 is absent.

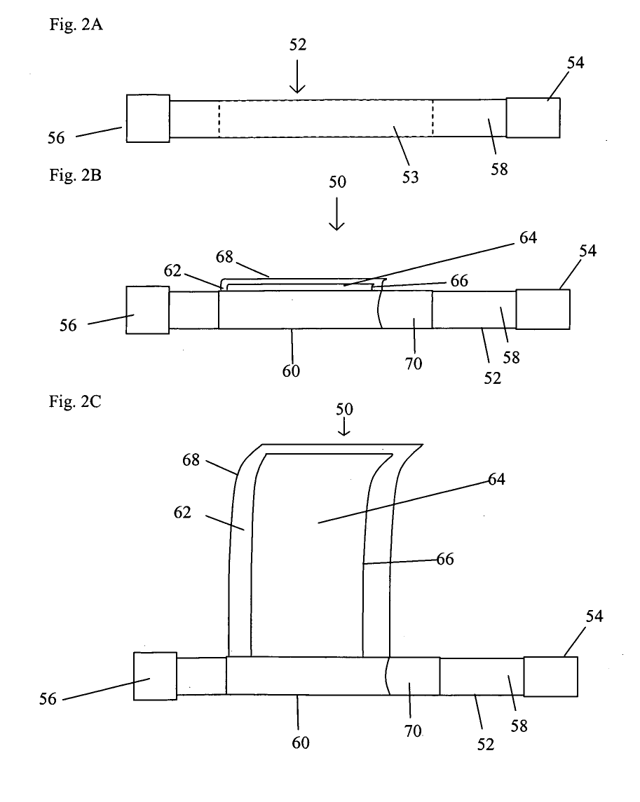

FIG. 2A shows a side view of a container 52, which in this embodiment consists of a proximal end cap 54, a distal end cap 56 and a barrel 58. Thus, the container depicted in FIG. 2A is advantageously similar to the automatic injector depicted in U.S. Pat. Nos. 5,540,664, 5,695,472, 5,358,489 and 5,665,071, as well as U.S. patent application States Ser. No. 11/006,382, filed on Dec. 6, 2004, each of which is expressly incorporated by reference. While the container depicted is an automatic injector as exemplified in one of the foregoing patent documents, the person skilled in the art will recognize that the container can be another type of container known in the art of pharmaceuticals. Without limitation, the container can be a glass or plastic medicine bottle, flexible tube, polymer bag, syringe, automatic injector, ampule, cannula, box or other container. The label of the invention is especially well suited to use on a container having a relatively small surface area.

FIGS. 2B and 2C show two different side views of a labeled device 50 according to the present invention. The labeled device 50 comprises a container 52 and a label 60. The container 52 has a proximal end cap 54, a distal end cap 56 and a barrel 58, to which the proximal end cap 54, distal end cap 56 and label 60 are affixed. The label 60 has a container adherent section 70 that is permanently affixed to the barrel 58 of the container 52. The label 60 also includes wrap section 68, which includes a first side 62, which bears a reversible adhesive strip 66 and includes a first writing section 64.

In FIG. 2A, the combination 50 is shown with the wrap section 68 almost fully wrapped or furled about the barrel 58 of the container 52. In FIG. 2B, the combination 50 is depicted with wrap section 68 in a substantially unfurled position. In this view it is possible to more clearly see the printing section 64. The person skilled in the art will recognize that the opposite side of the wrap section 68 may also bear appropriate printing.

FIG. 3A and FIG. 3B depict an end-on cross-sectional view of the device 50 in the furled (FIG. 3A) and unfurled (FIG. 3B) positions. The same reference numbers are used in FIG. 3A and 3B as are used in FIG. 2A and 2B.

In some embodiments, it is advantageous for the wrap label to be laminated, coated or otherwise treated to render it impervious to fluids such as water. In some particular embodiments, the label is coated over part or all of its surface with a polymer coating that is water-resistant or water-proof. In particularly advantageous embodiments, the label combines the properties of having: a large print area, a reversible adhesive applied to at least a portion of the wrap section and water-resistant or water-proof coating applied to at least part of the surface of the label. In particularly advantageous embodiments, the entire wrap section is coated with a water-resistant or water-proof coating. In other particularly advantageous embodiments, the entire wrap section and the side of the adherent section that does not adhere to the container (side B of adherent section 12 in FIG. 1B). In other embodiments, the entire label may be coated with a water-proof or water-resistant coating so long as the coating does not substantially interfere with the label's adherent section's ability to adhere to the container.

The wrap label of the present invention presents some distinct advantages over the prior art label. As has already been mentioned, the wrap label can be configured to conveniently display a much larger amount of useful information to the end user than a prior art label whose area is limited to the longitude times the circumference of the container. Referring to FIG. 1A, one can see that the maximum area available for printing on a conventional container label would be a*b, while the maximum area available for printing on a wrap label of the invention would be 2*c*d+a*b. If c were only three times b and d were equal to a, the total area of the wrap label would be 2*a*3*b+a*b=7*a*b. In other words, a wrap label that would wrap three times around the container would have seven times the useful printing area of the conventional label.

Another advantage of the wrap label according to the invention is that it provides some lateral cushioning during transportation of a pharmaceutical container. When it is wrapped around the container, the wrap label can act like a spring, absorbing forces applied perpendicular to the axis of the container. In the case of an automatic injector, this results in improved durability of the device.

What is claimed is:

1. An article comprising a container and a label, the label being affixed to the container, said label having a container adherent section and a wrap section, wherein said container adherent section is permanently affixed to an outer surface of the container and the wrap section is not directly affixed to the surface of the container and overlaps with at least a portion of the container adherent section, when the wrap label is furled around the container.

2. The article of claim 1, wherein the container is a syringe, an automatic injector, a bottle, an ampoule, a polymer bag or a box.

3. The article of claim 1, wherein the container has a label bearing portion to which the container adherent section is affixed, the label bearing portion being circular, square, rectangular, triangular, pentagonal, hexagonal, octagonal or oval in cross section.

4. The article of claim 1, wherein the container has a label bearing portion to which the container adherent section is permanently affixed, said label bearing portion having a circumference; further wherein the label has a total length consisting of an adherent section length and a wrap section length, wherein the adherent section length is measured along an edge of the container adherent section that goes around the circumference of the container and the wrap section length is measured along an edge of the wrap section that goes around the container circumference when the label is furled; wherein the container adherent section length is approximately equal to the circumference of the container.

5. The article of claim 1, wherein the container has a label bearing portion to which the container adherent section is permanently affixed, the label bearing portion having a circumference; further wherein the label has a total length consisting of an adherent section length and a wrap section length, wherein the adherent section length is measured along an edge of the container adherent section that goes around the circumference of the container and the wrap section length is measured along an edge of the wrap section that goes around the container circumference when the label is furled; wherein the adherent section length is greater than the circumference of the container.

6. The article of claim 5, wherein the adherent section length is less than about 10% greater than the circumference of the container.

7. The article of claim 1, wherein the container has a label bearing portion to which the container adherent section is permanently affixed, the label bearing portion having a circumference; further wherein the label has a total length consisting of an adherent section length and a wrap section length, wherein the adherent section length is measured along an edge of the container adherent section that goes around the circumference of the container and the wrap section length is measured along an edge of the wrap section that goes around the container circumference when the label is furled; wherein the container section length is less than the circumference of the container.

8. The article of claim 7, wherein the adherent section length is less than about 10% less than the circumference of the container.

9. The article of claim 1, wherein the container has a label bearing portion to which the container adherent section is permanently affixed, the label bearing portion having a circumference; further wherein the label has a total length consisting of an adherent section length and a wrap section length, wherein the adherent section length is measured along an edge of the container adherent section that goes around the circumference of the container and the wrap section length is measured along an edge of the wrap section that goes around the container circumference when the label is furled; wherein the adherent section length is less than the wrap section length.

10. The article of claim 9, wherein the wrap section length is at least about 2 times the container section length.

11. The article of claim 9, wherein the wrap section length is at least about 3 times the container the section length.

12. The article of claim 9, wherein the wrap length is from about 3 to about 15 times the circumference of the container.

13. The article of claim 1, wherein the adherent section has printing on one side and the wrap section has printing on one or both sides.

14. The article of claim 13, wherein the wrap section has printing on both sides.

15. The article of claim 1, wherein the label further comprises a resealable substance applied to a surface of the wrap section.

16. The article of claim 15, wherein the resealable substance is applied as a strip or one or more dots.

17. The article of claim 1, wherein the label further comprises perforations.

18. The article of claim 1, wherein a portion of said container adherent section is visible to a user when the wrap section is furled around the container.

19. The article of claim 18, wherein the portion of the container adherent section that is visible to a user when the wrap section is furled around the container has printed thereon an expiration date, a lot number or both.

20. A label comprising an adherent section and a wrap section, said adherent section having a first side and a second side, the first side being adapted to receive a permanent adhesive.

21. The label of claim 20, wherein said adherent section has a permanent adhesive applied thereto and said wrap section has substantially no permanent adhesive thereon.

22. The label of claim 20, wherein said wrap section has a first side and a second side, wherein the first side has a reversible adhesive applied thereto.

23. The label of claim 20, wherein said wrap section has printing on the first side, the second side or both sides.

24. The label of claim 23, wherein the wrap section has printing on both the first and second sides.

25. The label of claim 20, wherein the container adherent section has printing on the second side.

26. The label of claim 25, wherein the wrap section has printing on the first side, the second side or both.

27. The label of claim 26, wherein the wrap section has printing on both sides.

28. The label of claim 27, wherein the wrap section also has a reversible adhesive applied to either the first or second side thereof.

29. The label of claim 20, wherein the label is at least partly coated with a water-resistant or water-proof polymer coating.

30. The label of claim 20, wherein a container adherent section comprises a portion adapted to be visible to a user when the wrap section is furled around the container.

31. The label of claim 30, wherein the portion of the container adherent section that is adapted to be visible to a when furled around a container has printed thereon an expiration date, a lot number or both, whereby the expiration date, lot number, or both are adapted to be visible to a user when the wrap section is furled around the container.
